(19) United States
(12) Patent Application Publication
(10) Pub. No.: US 2025/0252075 A1
(43) Pub. Date: Aug. 7, 2025

(54) Network on Chip with Data Movement Processing Cores

(71) Applicant: Tenstorrent USA, Inc., Austin, TX (US)

(72) Inventors: Ivan Matosevic, Toronto (CA); Matthew Mattina, Boylston, MA (US); Syed Gilani, Markham (CA); Stanislav Sokorac, Austin, TX (US); Michael Smith, Toronto (CA)

(21) Appl. No.: 19/043,790

(22) Filed: Feb. 3, 2025

Related U.S. Application Data
(60) Provisional application No. 63/549,335, filed on Feb. 2, 2024.

(51) Int. Cl. G06F 15/80; G06F 9/38

(52) U.S. Cl. CPC G06F 15/80; G06F 9/3867

(57) ABSTRACT

Systems and methods related to a network on chip (NoC) with data movement processing cores are disclosed herein. For example, a system executing a complex computation may include multiple processing cores networked by an interconnect fabric and storing computational instructions and data movement instructions. Each processing core may include one or more memories, a computational pipeline, a core controller, a router, and a data movement processing core. Each data movement processing core may include a data movement core controller to administrate an execution of the data movement instructions and thereby generate commands for the corresponding router to route the computation data through the interconnect fabric during an execution of the complex computation. The data movement processing core may be valuable for addressing interconnect fabrics that are used for executing composite computations with unpredictable data movement patterns that require a high degree of flexibility.

### CROSS REFERENCE TO RELATED APPLICATIONS

This application claims the benefit of U.S. Provisional Patent Application No. 63/549,335, filed on Feb. 2, 2024, which is incorporated by reference herein in its entirety for all purposes.

### BACKGROUND

Networks-on-Chips (NoCs) represent a communication paradigm designed for multicore processors, addressing the challenges posed by the increasing number of processing cores on a single chip. These architectures employ network-like structures, utilizing diverse topologies such as mesh or torus, to interconnect cores efficiently. The choice of topology depends on factors like scalability and power efficiency. NoCs implement advanced routing algorithms, such as XY routing or wormhole routing, to optimize data transfer between cores, mitigating issues like bottlenecks and latency. By facilitating seamless on-chip communication, NoCs significantly contribute to enhancing the overall performance and scalability of multicore systems, offering a vital solution to the intricate challenges associated with the coordination and data exchange among multiple processing units.

In the implementation of NoCs, the intricate task of managing communication falls upon routers and network interface units (NIUs). Routers play a pivotal role in directing data packets between interconnected cores, utilizing the specified routing algorithms for efficient and timely communication. Network interface units act as intermediaries between the processing cores and the NoC, ensuring seamless data transfer. These units encapsulate the data into packets, handle protocol conversions, and manage the interaction with the NoC. Administrative tasks within NoCs are often overseen by relatively simple systems like Direct Memory Access (DMA) controllers, which facilitate the efficient movement of data between the main memory and the processing cores. By orchestrating these elements, NoCs not only optimize on-chip communication but also streamline the coordination between processing units and memory, contributing to the overall efficiency and performance of multicore processors.

### SUMMARY

Methods and systems related to NoCs are disclosed herein. In specific embodiments, the operations that are usually managed by elements such as DMA engines are handled by a fully functional processing core that offers enhanced flexibility and greater functionality to the administration of the NoC in terms of packet routing, data flow, and general data movement. The fully functional processing core can be a RISC-V core which is dedicated to the administration of the NoC. The fully functional processing cores can allow for software-controlled data movement administration during the execution of a composite computation by a network of computational nodes. These processing cores can be referred to as data movement processing cores to distinguish them from the processing cores of which they are a part. In other words, the NoC may be used to interconnect a set of processing cores which are executing a composite computation in combination, and each processing core can include a data movement processing core to administrate the movement of data and instructions between the processing cores in order to carry out that composite computation.

By using a fully functional and programmable processing core to administrate the NoC, several benefits can be realized. First, if a simple system like a DMA is utilized some data movements can be optimized while others are not. However, if a fully functional and programmable processing core is used instead, the configuration can be changed by software during execution of a composite computation and the NoC can be optimized for different data movements at different times. Furthermore, different sections of a shared or global distributed memory can be assigned to a specific core and each data movement processing core can maintain an address directory indicating which addresses are associated with each core. Furthermore, in specific embodiments each data movement processing core can maintain a table indicating where specific data elements or variables used in the complex computation are located so they can send specific requests for a given data element to the appropriate core. These tables and directories can be initialized and modified through the course of a composite computation using software. The tables and directories can be instantiated using programmable registers in the data movement processing cores that control the movement of data through the system.

In specific embodiments, the data movement processing cores can access blocks of data using a single load instruction in a global address space that is software configurable and can store blocks of data of varying sizes using a single store instruction in that global address space. Each data movement processing core can have access to an entire global address space. For example, each core could have 2 megabytes of memory and the NoC could link 100 cores such that the global address space must cover 200 megabytes of memory. The address space could be divided into ranges of 2-megabyte chunks with the tables keeping track of which core included which chunk such that a load request can be sent for an address in those chunks to the correct core.

Specific embodiments of these approaches are valuable for addressing NoCs that are used for executing composite computations with unpredictable data movement patterns that require a high degree of flexibility in the administration of data movement through the NoC. For example, the execution of modern artificial neural networks (ANNs) and other machine intelligence models tends to have unpredictable data movement patterns based on the activations to the network such that this field in particular can benefit from a NoC that uses data movement processing cores in accordance with this disclosure.

In specific embodiments of the invention, a system is provided. The system comprises a set of processing cores and a set of one or more memories, on the set of processing cores, storing computational instructions for component computations of a complex computation and storing data movement instructions for routing computation data for the complex computation. The system further comprises: an interconnect fabric that networks the set of processing cores, a set of computational pipelines on the set of processing cores, a set of core controllers on the set of processing cores to administrate an execution of the computational instructions by the set of computational pipelines, a set of routers on the set of processing cores, a set of data movement processing cores on the set of processing cores, and a set of data movement core controllers, on the set of data movement processing cores, to administrate an execution of the data movement instructions and thereby generate commands for the set of routers to route the computation data through the interconnect fabric during an execution of the complex computation.

In specific embodiments of the invention, a method in which each step is conducted by a set of processing cores, having a set of data movement processing cores, and an interconnect fabric that networks the set of processing cores is provided. The method comprises: storing, in one or more memories on the set of processing cores, computational instructions for component computations of a complex computation and data movement instructions for routing computation data for the complex computation; administrating, using a set of core controllers on the set of processing cores, an execution of the computational instructions for the component computations of the complex computation by a set of computational pipelines on the set of processing cores; administrating, using a set of data movement core controllers on the set of data movement processing cores, an execution of the data movement instructions; generating, via the execution of the data movement instructions, a set of commands for a set of routers on the set of processing cores; and routing, using the set of routers, the computation data through the interconnect fabric during an execution of the complex computation.

In specific embodiments of the invention, a processing core is provided. The processing core comprises: one or more memories storing computational instructions for component computations of a complex computation and data movement instructions for routing data for the complex computation, a computational pipeline, a core controller to administrate an execution of the computational instructions by the computational pipeline, a router having a network-on-chip interface, a data movement processing core, and a data movement core controller, on the data movement processing core, to administrate an execution of the data movement instructions and thereby generate commands for the router to route data for the complex computation on and off the processing core.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a network executing a complex computation, the network including two processing cores connected via an interconnect fabric in accordance with specific embodiments of the inventions disclosed herein.

FIG. 2 provides an example of a processing core including a data movement processing core, computational instructions, and data movement instructions in accordance with specific embodiments of the inventions disclosed herein.

FIG. 3 provides an example of a data movement processing core in accordance with specific embodiments of the inventions disclosed herein.

FIG. 4 provides an example of a network including multiple processing cores with a configurable global address space in accordance with specific embodiments of the inventions disclosed herein.

FIG. 5 provides an example of a processing core, including a data movement core controller and a core controller, reformatting data in accordance with specific embodiments of the inventions disclosed herein.

FIG. 6 provides an example of a method for using a set of data movement core controllers in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for a network on chip (NoC) with data movement processing cores in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

As used herein the term “interconnect fabric” refers to a hardware and software infrastructure that enables the efficient transfer of data between nodes within a computing system. It facilitates communication by connecting the computational nodes (e.g., processors, accelerators, or memory subsystems) and enabling data exchange within a common address space. This common address space allows nodes to reference and access data consistently. In systems with a shared memory architecture, the interconnect fabric facilitates seamless access to shared memory resources. This allows multiple computational nodes to read from and write to the same memory locations, enabling cooperative processing and data sharing. An interconnect fabric acts as the communication backbone in a computational system, such as those using a NoC, providing the mechanisms for data exchange, synchronization, and shared memory access across a distributed architecture with a unified address space. Interconnect fabrics also include hardware-level integration that directly facilitates data exchange between nodes, often with specialized routing, arbitration, and buffering mechanisms. A NoC is an example of an interconnect fabric.

The computational nodes can take on various forms. For example, the computational nodes can be any computing unit including a processor or core of a multicore processor. In specific embodiments, the computational nodes can be processing cores in a NoC. Although some of the specific examples provided herein are directed to a network of computational nodes in the form of a NoC connecting a set of processing cores, the approaches disclosed herein are broadly applicable to any form of network connecting any form of computational nodes that cooperate to execute a complex computation. Furthermore, networks in accordance with this disclosure can be implemented on a single chip system, including wafer-scale single chip systems, in a multichip single package system, or in a multichip multipackage system in which the chips are commonly attached to a common substrate such as a printed circuit board (PCB), interposer, or silicon mesh. Networks in accordance with this disclosure can also include chips on multiple substrates linked together by a higher-level common substrate such as in the case of multiple PCBs each with a set of chips where the multiple PCBs are fixed to a common backplane. Networks in accordance with this disclosure can also be implemented in chiplet based systems. For example, in specific embodiments of the invention, one or more computational nodes could be housed or implemented by one or more chiplets, connected, for example, through an interposer.

A core controller may be any grouping of circuitry that administrates the execution of instructions by the functional processing units of any form of computational node. A core controller may be a component of a computational node (e.g., processing core) that orchestrates the execution of instructions by the processor's functional processing units. A core controller may serve as the administrative hub of the computational node, ensuring the efficient coordination of operations within the computational node. The core controller may manage tasks such as instruction decoding, scheduling, and dispatching to various execution units like arithmetic logic units (ALUs), floating-point units (FPUs), or specialized accelerators. The core controller may also oversee control signals for memory access, data movement, and synchronization between internal components. In addition to facilitating the flow of instructions, a core controller may monitor and optimize resource allocation, addressing dependencies and resolving hazards to maintain high throughput and low latency. Whether in a single-core processor, a multi-core CPU, a GPU, or other computational nodes such as FPGAs or specialized accelerators, the core controller's role may extend to integrating system-wide communication protocols, managing power states, and maintaining coherence in shared memory architectures.

A computational pipeline may include the functional processing units of any form of computational node. A computational pipeline may refer to the structured, sequential flow of data and instructions through various stages of processing within a computational node. This concept may encompass the arrangement and coordination of functional processing units-such as arithmetic logic units (ALUs), floating-point units (FPUs), memory units, and specialized accelerators-designed to execute tasks in a streamlined and overlapping manner. A computational pipeline may break down complex computations into smaller, discrete stages, each handled by a specific functional unit. This design may allow multiple instructions or data sets to be processed simultaneously at different stages, maximizing throughput and efficiency. Computational pipelines may be incorporated into a wide range of systems, from traditional central processing units (CPUs) with instruction pipelines for executing machine-level commands to graphics processing units (GPUs) optimized for massive parallelism and specialized hardware like tensor cores or field-programmable gate arrays (FPGAs). Whether in scalar, vectorized, or parallel processing architectures, the pipeline may dynamically manage the flow of operations, mitigating bottlenecks through techniques such as instruction reordering, hazard resolution, and caching.

Methods and systems related to interconnect fabrics (e.g., NoCs) with data movement processing cores are disclosed herein. In specific embodiments, the operations that are usually managed by elements such as DMA engines are handled by a fully functional processing core that offers enhanced flexibility and greater functionality to the administration of the interconnect fabric in terms of packet routing, data flow, and general data movement. The fully functional processing core can be a RISC-V core which is dedicated to the administration of an interconnect fabric (e.g., NoC). The fully functional processing cores can allow for software-controlled data movement administration during the execution of a composite computation by a network of computational nodes. These processing cores can be referred to as data movement processing cores to distinguish them from the processing cores of which they are a part. In other words, the interconnect fabric (e.g., NoC) may be used to interconnect a set of processing cores (or other computational nodes) which are executing a composite computation in combination, and each processing core can include a data movement processing core to administrate the movement of data and instructions between the processing cores in order to carry out that composite computation.

For example, a system executing a complex computation may include multiple computational nodes networked by an interconnect fabric. The computational nodes may each include one or more memories, one or more computational pipelines, one or more computational node controllers, one or more routers, and one or more data movement processing cores. Each data movement processing core may include a data movement processing core controller. The data movement processing core controller may administrate an execution of the data movement instructions and thereby generate commands (e.g., instructions) for the one or more corresponding router to route computation data through the interconnect fabric during the execution of the complex computation. The one or more memories may store computational instructions for component computations of the complex computation and may store the data movement instructions for routing computation data for the complex computation. The one or more computational instructions may execute the computational instructions. The one or more computational node controllers may administrate the execution of the computational instructions by the one or more computational pipelines.

The data movement processing core may be capable of a variety of functions. For example, a data movement processing core may execute compiled instruction sets, allowing it to be programmed for complex and dynamic behaviors. The data movement processing core may fetch, decode, and execute a sequence of instructions, from an instruction memory or cache in the data movement processing core. The data movement processor core may evaluate conditions and make decisions during runtime (e.g., if-else statements and loops) to inspect data packets and dynamically adjust routing paths based on measured or estimated latencies. A combination of arithmetic logic units (ALUs), instruction decode states, program counters, branch target calculation logic, and other structures may enable, during instruction execution, conditional branching and decision-making in the data movement processor core. The data movement processor core may calculate or determine source and destination addresses during runtime, enabling dynamic routing decisions (e.g., selecting an optimal path in a NoC or keeping track of and taking actions with respect to a global addressing scheme). Additionally, the data movement processing core may route and prepare data in accordance with external or higher-level protocols (e.g., Ethernet).

By using a fully functional and programmable processing core, such as a data movement processing core, to administrate the interconnect fabric, several benefits can be realized. First, if a simple system like a DMA is utilized, some data movements can be optimized while others are not. However, if the data movement processing core is used instead, the configuration can be changed by software during execution of a composite computation and the interconnect fabric can be optimized for different data movements at different times. Furthermore, different sections of a shared or global distributed memory can be assigned to a specific core and each data movement processing core can maintain an address directory indicating which addresses are associated with each core. Furthermore, in specific embodiments, each data movement processing core can maintain a table indicating where specific data elements or variables used in the complex computation are located so they can send specific requests for a given data element to the appropriate core. These tables and directories can be initialized and modified through the course of a composite computation using software. The tables and directories can be instantiated using programmable registers in the network control processing cores that control the movement of data through the system.

In specific embodiments, the data movement processing cores can access blocks of data using a single load instruction in a global address space that is software configurable and can store blocks of data of varying sizes using a single store instruction in that global address space. Each data movement processing core can have access to an entire global address space. For example, each core could have 2 megabytes of memory and the interconnect fabric could link 100 cores such that the global address space must cover 200 megabytes of memory. The address space could be divided into ranges of 2-megabyte chunks with the tables keeping track of which core included which chunk such that a load request can be sent for an address in those chunks to the correct core.

Specific embodiments of these approaches are valuable for addressing interconnect fabrics (e.g., NoCs) that are used for executing composite computations with unpredictable data movement patterns that require a high degree of flexibility in the administration of data movement through the interconnect fabric. For example, the execution of modern artificial neural networks (ANNs) and other machine intelligence models tends to have unpredictable data movement patterns based on the activations to the network such that this field in particular can benefit from an interconnect fabric that uses data movement processing cores in accordance with this disclosure.

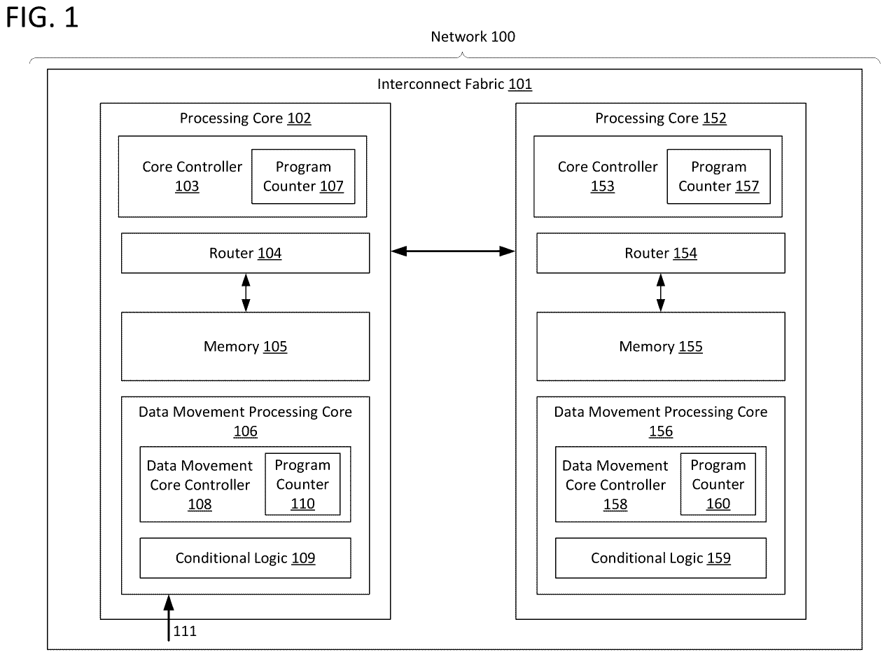

FIG. 1 illustrates an example of network 100 executing a complex computation, network 100 including processing core 102 and processing core 152 connected via interconnect fabric 101 in accordance with specific embodiments of the inventions disclosed herein. Processing core 102 includes core controller 103, router 104, memory 105, and data movement processing core 106. Memory 105 may be a representation of multiple different memories (e.g., caches, registers, dynamic random-access memory (DRAM), static random-access memory (SRAM), scratch pad, etc.). In specific embodiments, processing core 102 may include a processing pipeline. Core controller 103 may include program counter 107. Data movement processing core 106 may include data movement core controller 108 and conditional logic 109. Data movement core controller 108 may include program counter 110. In specific embodiments, program counter 107 and program counter 110 may be distinct or independent program counters. Processing core 152 may similarly include core controller 153, program counter 157, router 154, memory 155, data movement processing core 156, data movement core controller 158, program counter 160, and conditional logic 159. As components of processing core 102 are described, the descriptions may also apply to corresponding elements in processing core 152. Although two processing cores are shown, network 100 may include any number of processing cores or computational nodes. In specific embodiments, core controller 103 may be a control unit in a RISC-V architecture and data movement processing core 106 may be a RISC-V processing core.

Core controller 103 may administrate an execution of the computational instructions by a computational pipeline. Core controller 103 may coordinate the flow of computational instructions, manage resources, and ensure efficient operation of the computational pipeline across various stages. For example, core controller 103 may fetch computational instructions from memory 105. Program counter 107 may identify the memory address of the next computational instruction. If branches are present, a branch prediction unit may predict a likely outcome to keep the pipeline filled. Fetched computational instructions may be decoded. For example, an instruction decode unit may translate raw computational instructions into microoperations or control signals that specify the tasks for the functional units. Core controller 103 may identify operand requirements and may allocate resources (e.g., reservation stations, issue slots, etc.). Core controller 103 may schedule and dispatch computational instructions to the appropriate pipeline stages or functional units, supervise instruction execution, manage interaction with caches and memory hierarchies, write back results, monitor and optimize operation of the pipeline, handle exceptions or interrupts during instruction execution, synchronize execution across cores, optimize energy consumption, and prevent overheating.

Data movement core controller 108 may administrate an execution of data movement instructions and may thereby generate commands for router 104 to route computation data through interconnect fabric 101 during the execution of the complex computation. The commands for router 104 may be lower-level instructions. Data movement core controller 108 may coordinate the flow of data movement instructions and manage resources. For example, data movement core controller 108 may fetch data movement instructions from memory 105. Program counter 110 may identify the memory address of the next data movement instruction. If branches are present, a branch prediction unit may predict a likely outcome. Fetched data movement instructions may be decoded. For example, an instruction decode unit of data movement processing core 106 may translate raw data movement instructions into microoperations or control signals that specify the tasks for the functional units. Data movement core controller 108 may identify operand requirements and may allocate resources. Data movement core controller 108 may schedule and dispatch data movement instructions to router 104 or functional units, supervise instruction execution, manage interaction with caches and memory hierarchies, write back results, handle exceptions or interrupts during instruction execution, synchronize execution across cores, optimize energy consumption, and prevent overheating.

In specific embodiments, processing core 102, processing core 152, data movement core controller 108, and data movement core controller 158 of processing core 152 may each use their own separate program counters. That is, program counter 107 (of processing core 102), program counter 110 (of data movement processing core 106), program counter 157 (of processing core 152), and program counter 160 (of data movement processing core 156) may each be different program counters. For example, the program counters 107, 110, 157, and 160 may each be independent, asynchronous, or may otherwise operate according to their own instruction list. Each program counter 107, 110, 157, and 160 may track a current execution point of an instruction set of the corresponding core. For example, each program counter 107, 110, 157, and 160 may include a register that contains a memory address of a next instruction to be executed by the respective core.

Data movement processing core 106 may reformat the computation data during the execution of the complex computation. Reformatting the computation data may include changing a data type (e.g., integer, floating point, etc.) of the computation data, changing a compression state (e.g., compressed, uncompressed) of the computation data, and/or changing a quantity (e.g., one packet to multiple packets) of data structures storing the computation data. The computation data may be stored in memory 105. These reformatting operations can be conducted according to a fixed ex ante determination defined by the data movement instructions that are to be executed by the data movement processing cores or dynamically during the execution of a complex computation such as by using conditional logic 109.

Data movement processing core 106 may receive information 111 regarding the state of interconnect fabric 101 during the complex computation. Conditional logic 109 may use information 111 regarding the state of interconnect fabric 101. In specific embodiments, conditional logic 109 may use information 111 to reformat the computation data. For example, if information 111 indicates that interconnect fabric 101 is busy or crowded, conditional logic 109 may compress the computational data.

Data movement processing core 106 may reconfigure a state of router 104 during the execution of the complex computation. Reconfiguring the router can include dynamically changing arbitration policies, adjusting flow control mechanisms, reconfiguring security policies, adjusting power and frequency scaling, changing buffering or memory copy policies, dynamic buffer resizing, and other configuration modifications.

Data movement processing core 106 may receive information 111 regarding the state of interconnect fabric 101 during the complex computation. Conditional logic 109 may use information 111 regarding the state of interconnect fabric 101. In specific embodiments, conditional logic 109 may use information 111 to reconfigure a state of router 104. For example, if information 111 indicates that interconnect fabric 101 is busy or crowded, conditional logic 109 may increase the size of the buffers available for the routers.

Router 104 may be communicatively coupled with memory 105. The communication path between router 104 and memory 105 may include other components or elements of processing core 102, or may be a direct route. Router 104 may move computation data from memory 105 (e.g., a scratch pad memory in memory 105) through interconnect fabric 101. That is, computational data may be moved out of processing core 102 (e.g., off a chip) via a scratchpad in memory 105. The communication data may be transported through interconnect fabric 101 to processing core 152, to another processing core (not shown), or to another component of network 100.

In specific embodiments, the operations that are usually managed by elements such as DMA engines are handled by a fully functional processing core, such as data movement processing core 106, that offers enhanced flexibility and greater functionality to the administration of the interconnect fabric in terms of packet routing, data flow, and general data movement. The fully functional processing core can be a RISC-V core which is dedicated to the administration of an interconnect fabric (e.g., NoC). The fully functional processing core can allow for software-controlled data movement administration during the execution of a composite computation by a network of computational nodes such as network 100. Interconnect fabric 101 (e.g., NoC) may be used to interconnect processing cores 102, 152, and others (not shown) which are executing a composite computation in combination, and each processing core can include a data movement processing core to administrate the movement of data and instructions between the processing cores in order to carry out that composite computation.

By using data movement processing core 106 (e.g., a fully functional and programmable processing core) to administrate interconnect fabric 101, several benefits can be realized. First, if a simple system like a DMA is utilized, some data movements can be optimized while others are not. However, if the data movement processing core is used instead, the configuration can be changed by software during execution of a composite computation and the interconnect fabric can be optimized for different data movements at different times. Furthermore, different sections of a shared or global distributed memory can be assigned to a specific core and each data movement processing core can maintain an address directory indicating which addresses are associated with each core. Furthermore, in specific embodiments, each data movement processing core can maintain a table indicating where specific data elements or variables used in the complex computation are located so they can send specific requests for a given data element to the appropriate core. These tables and directories can be initialized and modified through the course of a composite computation using software. The tables and directories can be instantiated using programmable registers in the network control processing cores that control the movement of data through the system.

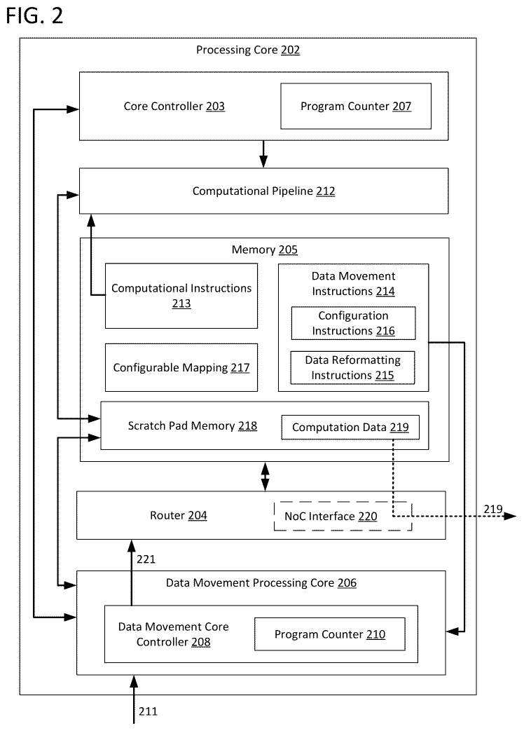

FIG. 2 illustrates an example of processing core 202 with data movement processing core 206, computational instructions 213, and data movement instructions 214 in accordance with specific embodiments of the inventions disclosed herein. Processing core 202 may include core controller 203, computational pipeline 212, memory 205, router 204, and data movement processing core 206. Core controller 203 may include program counter 207. In specific embodiments, data movement processing core 206 (e.g., data movement core controller 208) may include program counter 210, which may be separate from or independent of program counter 207. Data movement processing core 206 may include data movement core controller 208. In specific embodiments, router 204 may include NoC interface 220 (or an interface with a different type of interconnect fabric). Memory 205 may store computational instructions 213, data movement instructions 214, and configurable mapping 217; and memory 205 may include scratch pad memory 218. Data movement instructions 214 may include data reformatting instructions 215 and configuration instructions 216. Scratch pad memory 218 may store (e.g., include) computation data 219. Memory 105 may be a representation of multiple different memories (e.g., caches, registers, DRAM, SRAM, etc.). Scratch pad memory 218 may be a representation of multiple different scratch pad memories. Examples of simplified communication paths are shown in FIG. 2, however more communication paths may be present, communication paths may include other components of the system, and communication paths may not be direct. Aspects of processing core 202 may be similar to aspects of processing core 102 or processing core 152. Processing core 202 may be part of a network of processing cores executing a complex computation and networked by an interconnect fabric.

Router 204 and scratch pad memory 218 may be communicatively coupled. Router 204 may move computation data 219 from scratch pad memory 218 through an interconnect fabric that networks processing core 202 with another processing core. In specific embodiments, router 204 may include or have NoC interface 220 (or an interface with a different type of interconnect fabric).

Computational instructions 213 may be for component computations of the complex computation. Data movement instructions 214 may be for routing data for the complex computation. Computational instructions 213 and data movement instructions 214 may be part of the same instruction set or may be part of different instruction sets. Both computational instructions 213 and data movement instructions 214 may be a RISC-V instruction set.

Core controller 203 may administrate an execution of computational instructions 213 by computational pipeline 212. Data movement core controller 208 may administrate an execution of data movement instructions 214 and thereby generate commands (such as command 221) for router 204 to route data for the complex computation on and off processing core 202 (e.g., to route computation data 219 through the interconnect fabric). For example, core controller 203 and data movement core controller 208 may fetch their respective instructions from memory 205. Program counters 207 and 210 may identify the memory address of the next respective instruction. Branch prediction units may predict likely outcomes for the instructions. Fetched data movement instructions may be decoded. Core controller 203 and data movement core controller 208 may schedule and dispatch instructions, supervise instruction execution, manage interaction with caches and memory hierarchies, write back results, handle exceptions or interrupts during instruction execution, synchronize execution across cores, optimize energy consumption, and prevent overheating.

Computational pipeline 212 and data movement processing core 206 can both have access (e.g., both read and write) to scratch pad memory 218 (e.g., the same local scratch pad memory), for example to reformat computation data 219. Both instructions (e.g., kernels) and data may be stored in the local scratch pad memory. For example, computational instructions 213, data movement instructions 214, computation data 219, and data related to data movement may be stored in scratch pad memory 218.

A subset of data movement instructions 214 may be configuration instructions 216. Configuration instructions 216 may be executed to set the state of a router such as router 204. Configuration instructions 216 may alternatively be for a configurable global address space for a set (e.g., a network) of processing cores including processing core 202. Processing core 202 may store configurable mapping 217 that maps the configurable global address space to physical addresses in memory 205. Configurable mapping 217 may be a portion of a complete mapping spread across processing cores in the set of processing cores, the set including processing core 202. The mapping may map the configurable global address space to physical addresses in memories across the set of processing cores including in memory 205 of processing core 202.

A subset of data movement instructions 214 may be data reformatting instructions 215. Data reformatting instructions 215 may change a data type of computation data 219. For example, data reformatting instructions 215 may change computation data 219 from a floating point to an integer or vice versa. Data reformatting instructions 215 may change a compression state of the computation data 219. For example, data reformatting instructions 215 may change computation data 219 from an uncompressed state to a compressed state. Data reformatting instructions 215 may change a quantity of data structures storing computation data 219. For example, data reformatting instructions 215 may change computation data 219 from a single packet to multiple packets. Data movement processing core 206 may receive information 211 regarding the state of the interconnect fabric during the complex computation. Conditional logic in data movement processing core 206 may use information 211 regarding the state of interconnect fabric 101 (e.g., to reformat computation data 219). For example, if information 211 indicates that the interconnect fabric is not busy or crowded, data movement processing core 206 may refrain from compressing computation data 219.

The computational portion (e.g., computational pipeline 212, core controller 203) and data movement portion (e.g., data movement processing core 206) of processing core 202 may communicate with each other. In specific embodiments, processing core 202 and data movement processing core 206 may communicate using interrupts. For example, data movement processing core 206 may emit a signal to alert processing core controller 203 to a high-priority process that may require interruption of the current working process of core controller 203. Core controller 203 may inform data movement processing core 206 that the interrupt signal has been received. After the interrupt is handled, core controller 203 may resume any activities that may have been interrupted. Processing core 202 and data movement processing core 206 may send interrupts via a programmable interrupt controller and may notify each other of changes in state (e.g., in real time). Processing core 202 and data movement processing core 206 may pass interrupts and may pause an execution in a set of instructions to wait for an interrupt. Interrupts can also be used in either direction to assure that computational data for the computational pipeline is available from the NoC in memory and that computational data for the NoC is available from the computational pipeline in memory. In specific embodiments, the interrupts can be programmed into the data movement instructions and the computational instructions to assure that the correct data is available in memory for either the computational pipeline or the data movement processing core.

Processing core 202 and data movement processing core 206 may operate together similar to a system of heterogeneous cores operating together, without a master-slave relationship. Processing core 202 and data movement processing core 206 may independently execute instructions but may communicate with each other, such as communicating information regarding the completion of an instruction. Processing core 202 and data movement processing core 206 may use a collection of communication protocols and subroutines to communicate. Processing core 202 and data movement processing core 206 may use shared memory (e.g., cache, registers, scratchpad, buffers, etc.), send and receive messages, and communicate in other ways.

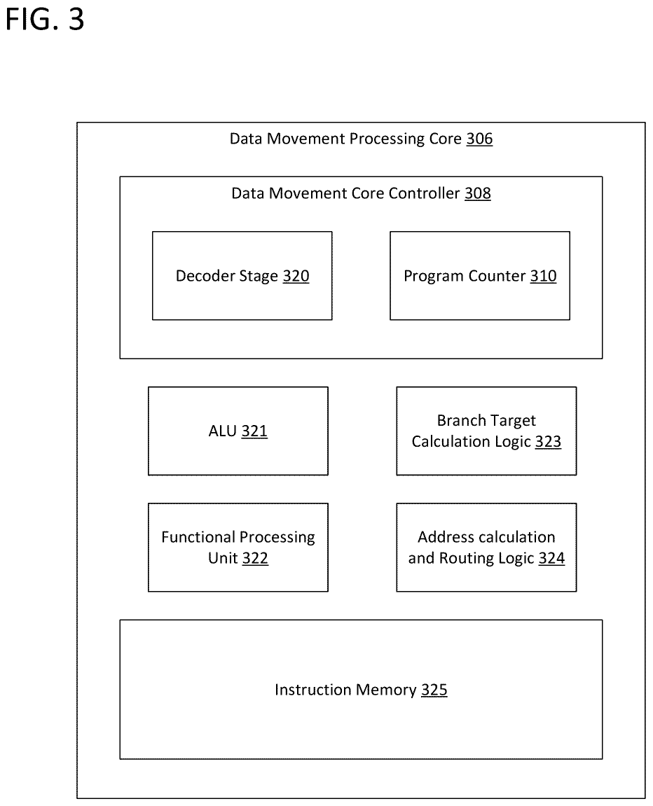

FIG. 3 illustrates an example of data movement processing core 306 in accordance with specific embodiments of the inventions disclosed herein. Data movement processing core 306 includes data movement core controller 308, arithmetic logic unit (ALU) 321, functional processing unit 322, branch target calculation logic 323, address calculation and routing logic 324, and instruction memory 325. Data movement core controller 308 may include program counter 310 and decoder stage 320. Decoder stage 320 may be logic that performs decoding in an instruction decode stage of an instruction cycle.

Data movement processing core 306 may include other hardware components related to processing cores. For example, data movement processing core 306 may also include an instruction fetch unit (e.g., instruction cache, branch prediction unit), instruction decode unit (e.g., instruction buffer, operand fetch logic), execution control unit (e.g., scheduler, dispatch unit, reservation stations), functional unit controllers (e.g., arithmetic logic unit control, floating point unit control, specialized units, specialized processing unit management), register management unit (e.g., register file, renaming unit, operand bypass logic), memory access unit (e.g., load/store unit, data cache, memory order buffer, prefetcher), control logic (e.g., pipeline control logic, stall detection and recovery logic, clock gating logic), branch prediction unit (e.g., branch target buffer, global history register), cache and memory management components (e.g., translation lookaside buffer, cache controllers, coherence protocol logic), interrupt and exception handlers (e.g., interrupt controller, fault detection logic), power and thermal management components (e.g., dynamic voltage and frequency scaling logic, thermal sensors), debug and performance monitoring units (e.g., performance counters, debug registers), interconnect logic (e.g., bus or network interface, crossbar switches or NoC controllers), and synchronization mechanisms. Program counter 310 may be part of the instruction fetch unit. Decoder stage 320 may include decoder logic and decoder circuits and may be part of the instruction decode unit. ALU 321 may be controlled by the ALU control of the functional unit controller. Branch target calculation logic 323 may be part of the branch prediction unit. Data movement processing core 306 may can execute compiled instruction sets, allowing it to be programmed for complex and dynamic behaviors. Data movement processing core 306 may include instruction memory 325 (e.g., an instruction cache). Data movement processing core 306 may fetch, decode, and execute a sequence of instructions from instruction memory 325.

In specific embodiments, data movement core controller 308 may be part of a set of data movement core controllers within their respective processing cores, where the data movement core controllers all use their own separate program counters. For example, program counter 310 may be specific to data movement core controller 308; and data movement core controller 308 may be specific to data movement processing core 306.

Data movement processing core 306 may evaluate conditions and make decisions during runtime (e.g., if-else statements and loops). Data movement processing core 306 may, accordingly, inspect data packets and dynamically adjust routing paths based on measured or estimated latencies. ALU 321, decoder stage 320, program counter 310, branch target calculation logic 323, and other structures may enable conditional branching or decision-making by data movement processing core 306 during instruction execution.

Data movement processing core 306 may calculate or determine source and destination addresses during runtime, enabling dynamic routing decisions (e.g., selecting an optimal path in a NoC or keeping track of and taking actions with respect to a global addressing scheme). ALU 321, address calculation and routing logic 324, or other computational units may perform or assist in performing the calculations or determinations of the source and destination addresses during runtime.

Data movement processing core 306 may route and prepare data in accordance with external or higher-level protocols (e.g., Ethernet). For example, data movement processing core 306 may route and prepare the data using instruction memory 325, program counter 310, and other components.

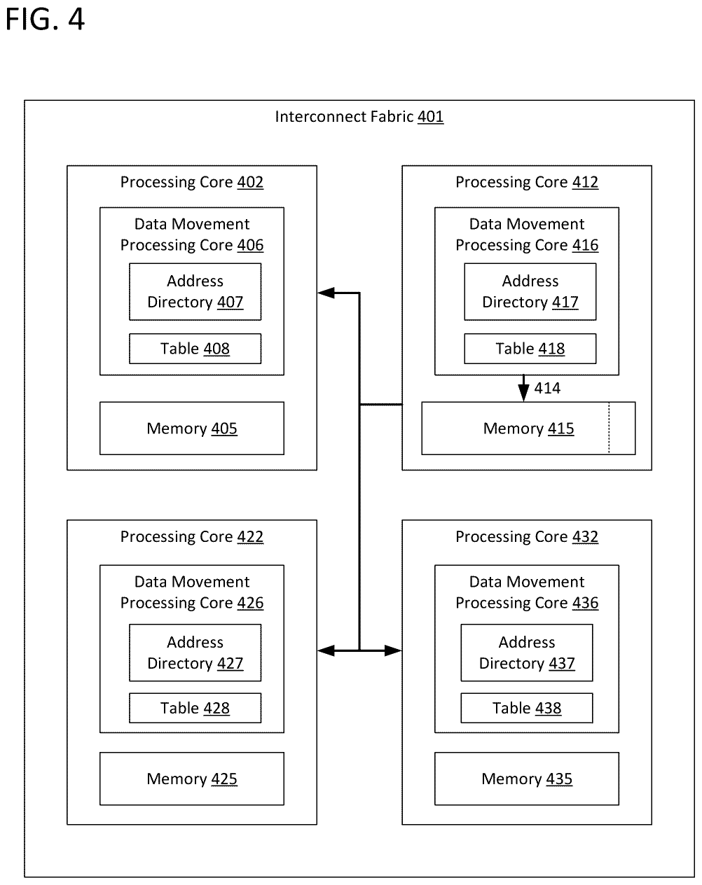

FIG. 4 illustrates an example of a configurable global address space in a network including processing cores 402, 412, 422, and 432 in accordance with specific embodiments of the inventions disclosed herein. Interconnect fabric 401 links four processing cores 402, 412, 422, and 432. Each processing core 402, 412, 422, and 432 has its own local memory 405, 415, 425, and 435 respectively and includes a data movement processing core 406, 416, 426, and 436 respectively. Although only four processing cores are shown, any quantity of processing cores may be incorporated in the global address space. Data movement processing cores may allow the system more control over the global address space.

All memory locations may be accessible to each processing core 402, 412, 422, and 432 via a common address space. The common address space may be physically shared or virtually mapped. The layout, size, and access privileges of the address space may be dynamically adjusted based on application requirements or hardware capabilities. Configurations may include partitioning memory, mapping virtual to physical addresses, or specifying memory regions as shared or private. In specific embodiments, access to the global address space may be controlled to optimize performance, such as enabling cache coherence, defining consistency models, or adjusting latency and bandwidth for specific applications. Configurations may be adjusted to improve cache locality, reduce latency, and balance memory bandwidth across processors or threads.

Physical memory locations may be mapped to the global address space, which may include local memory, shared memory, or remote memory segments. The global address space may be dynamically configured; for example, the global address space may be adjusted at runtime based on workload changes, resource usage, or application demands. Configurable memory protection mechanisms may regulate which parts of the address space are accessible by different processing entities (e.g., cores). Address translation (e.g., via a memory management unit (MMU)) may ensure that virtual addresses in the global space map to the correct physical addresses. Memory consistency models (e.g., strict, relaxed, or eventual consistency) may dictate how updates to memory are visible to other processing units.

By using data movement processing core 406, 416, 426, and 436, different sections of the shared or global distributed memory can be assigned to a specific processing core 402, 412, 422, and 432. Each data movement processing core 406, 416, 426, and 436 can maintain an address directory (407, 417, 427, and 437 respectively) indicating which addresses are associated with each processing core 402, 412, 422, and 432. Furthermore, in specific embodiments, each data movement processing core 406, 416, 426, and 436 can maintain a table (408, 418, 428, and 438 respectively) indicating where specific data elements or variables used in the complex computation are located so the data movement processing cores can send specific requests for a given data element to the appropriate processing core. Tables 408, 418, 428, and 438 and address directories 407, 417, 427, and 437 can be initialized and modified through the course of a composite computation using software. Tables 408, 418, 428, and 438 and address directories 407, 417, 427, and 437 may be instantiated using programmable registers in the network control processing cores that control the movement of data through the system.

In specific embodiments, data movement processing cores 406, 416, 426, and 436 may access blocks of data using a single load instruction in a global address space that is software configurable and can store blocks of data of varying sizes using a single store instruction in that global address space. Each data movement processing core 406, 416, 426, and 436 may have access to an entire global address space. In the example of FIG. 4, each core has 2 megabytes of memory and interconnect fabric 401 links four processing cores 402, 412, 422, and 432 such that the global address space covers eight megabytes of memory. The address space could be divided into ranges of 2-megabyte chunks with the tables keeping track of which core included which chunk such that a load request can be sent for an address in those chunks to the correct processing core.

Data movement processing core 416 may include data movement instructions. A subset of the data movement instructions may be configuration instructions for the configurable global address space for the set of processing cores 402, 412, 422, and 432. The set of processing cores 402, 412, 422, and 432 may store a configurable mapping that maps the configurable global address space to physical addresses in the set of memories 405, 415, 425, and 435. In the example of FIG. 4, the global memory is divided among processing cores 402, 412, 422, and 432 with mapping on each processing cores 402, 412, 422, and 432. Data movement instruction 414 may allocate more addresses of the global distributed memory to memory 415 of processing core 412. Accordingly, the mapping for the global distributed memory may update on processing cores 402, 412, 422, and 432. In specific embodiments, data movement instruction 414 may be stored in data movement processing core 416 and processing core 412 may send mapping changing commands to processing cores 402, 422, and 432. In specific embodiments, the data movement reallocation and mapping updates may be performed by an MMU, an operating-system level memory manager, etc.

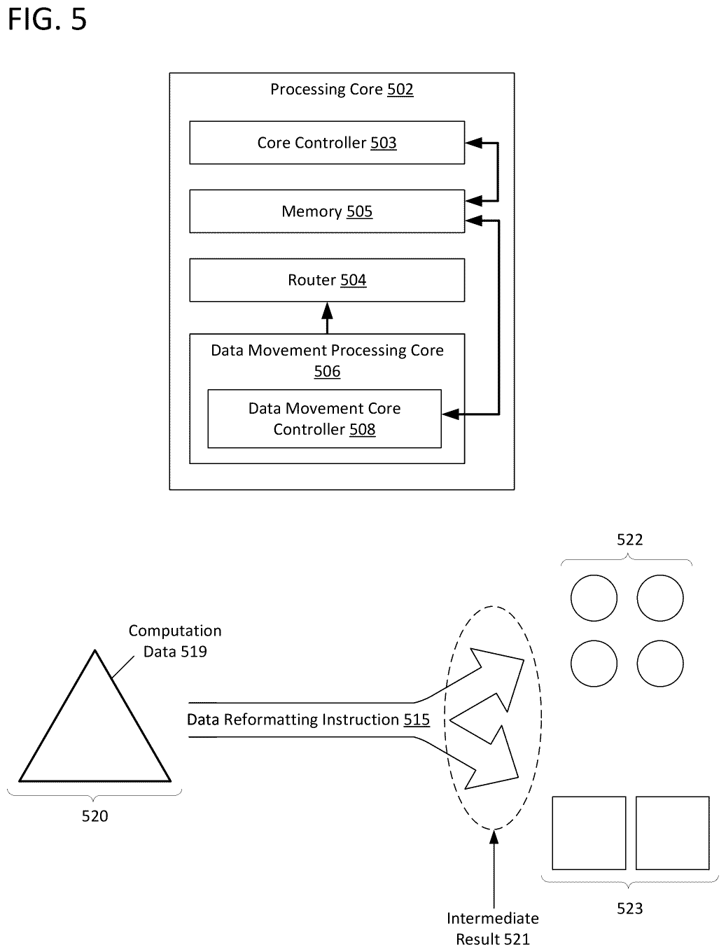

FIG. 5 illustrates an example of processing core 502 with data movement core controller 508 and core controller 503 reformatting data in accordance with specific embodiments of the inventions disclosed herein. A subset of data movement instructions in memory 505 may be data reformatting instructions such as data reformatting instruction 515. Both core controller 503 and data movement core controller 508 may read and write to memory 505. Data movement processing core 506 may send instructions or commands to router 504. A representation of data reformatting (by data movement core controller 508) is shown in FIG. 5; format 520, format 522, and format 523 may be examples of computation data 519 in different formats. Data movement processing core 506 may reformat data as it is moved. For example, data movement processing core 506 may change the type of the data (e.g., integer to floating point), change the compression state of the data (e.g., from compressed to uncompressed), break the data up into different pieces for delivery to a receiving core as multiple data structures as opposed to one big one, etc.

Data reformatting instruction 515 may be executed without the computation data that is reformatted flowing through a computational pipeline. That is, data movement processing core 506 may reformat computation data without the use of an instruction pipeline or without the computation data being sent through the computational pipeline. Both core controller 503 and data movement core controller 508 may read and write to memory 505 (e.g., a scratch pad memory) to reformat computation data. Data movement processing core 506 may reformat computation data 519 during the execution of the complex computation and using conditional logic. Reformatting computation data may include a combination of changes to the computation data's data type, compression state, quantity of data structures, etc. Data movement processing core 506 may send instructions or commands to router 504. The instructions or commands may include reformatted computation data (e.g., in format 522 or format 523)

Data reformatting instructions may reformat computation data in a manner that is dependent upon intermediate results of the execution of the complex computation. That is, computation data may be reformatted dynamically throughout the execution of the complex computation. For example, computation data may be reformatted based on results, outcomes, and intermediates of the complex computation while the complex computation is being executed as opposed to being reformatted based on determinations made previous to the execution (or partial execution) of the complex computation. In the example of FIG. 5, data reformatting instruction 515 may reformat computation data 519 from format 520 into format 522 or format 523 based on intermediate result 521. Intermediate result 521 may be a result of an if-statement, a branching instruction, a branch prediction, etc. Intermediate result 521 may determine a condition that affects how data reformatting instruction 515 reformats computation data 519. For example, intermediate result 521 may determine whether computation data is reformatted to format 522 or reformatted to format 523. In specific embodiments, intermediate result 521 may determine how to reformat data (e.g., either to format 522 or format 523) or whether to reformat data (e.g., keep format 520 or reformat the data).

Data reformatting instructions may change a data type of the computation data. For example, data reformatting instruction 515 may change computation data 519 from a floating point to an integer or vice versa. In the example of FIG. 5, format 520 may be a signed integer type while format 522 may be a floating point type and format 523 may be an unsigned integer type.

Data reformatting instructions may change a compression state of the computation data. For example, data reformatting instruction 515 may change computation data 519 from an uncompressed state to a compressed state. In the example of FIG. 5, format 520 may be uncompressed while format 522 may be compressed and format 523 remains uncompressed.

Data reformatting instructions may change a quantity of data structures storing computation data. For example, data reformatting instruction 515 may change computation data 519 from a single packet to multiple packets or from multiple packets to a single packet. In the example of FIG. 5, format 520 may be a single packet (e.g., a single large tensor) while format 522 may divide computation data 519 into four packets (portions of the tensor) and format 523 may divide computation data into two packets (portions of the tensor).

Data reformatting may be based on information regarding the state of the interconnect fabric. Data movement processing core 506 may receive information regarding a state of the interconnect fabric during the complex computation. Conditional logic in data movement processing core 506 may use the information regarding the state of the interconnect fabric. For example, the conditional logic data may use the information regarding the state of the interconnect fabric to determine whether or how to reformat computation data. That is, decisions about reformatting data may be made as the complex computation is executed (e.g., opposed to previous to the execution). Computation data may be reformatted in different ways using logic. For example, if the interconnect fabric is busy, then data movement processing core 506 may compress computation data; data movement processing core 506 may exert extra overhead to compress the computation data to reduce strain on the interconnect fabric. If the interconnect fabric is not busy, then data movement processing core 506 may refrain from compressing the computation data; data movement processing core 506 may refrain from exerting extra overhead to compress computation data because the interconnect fabric has sufficient resources to efficiently transport the uncompressed computation data.

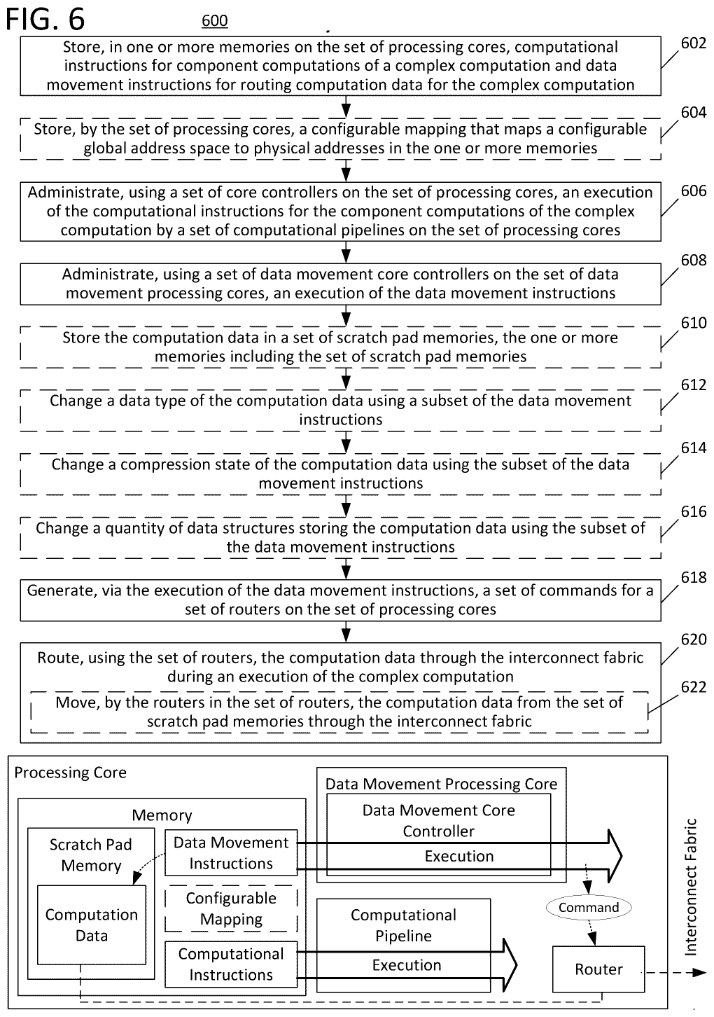

FIG. 6 illustrates an example of method 600 for using a set of data movement core controllers in accordance with specific embodiments of the inventions disclosed herein. Each step of method 600 may be conducted by a set of processing cores and an interconnect fabric that networks the set of processing cores. The set of processing cores may have a set of data movement processing cores. In specific embodiments, the data movement processing cores in the set of data movement processing cores may each include a functional processing unit. Method 600 may be implemented by a system including the means for performing steps of method 600. Steps or portions of steps may be duplicated, omitted, or rearranged. Steps may be added to method 600. Steps or portions of steps of method 600 may be performed in series or parallel. Some steps of method 600 may be completed as part of other steps.

At step 602, computational instructions and data movement instructions may be stored in one or more memories on the set of processing cores. The computational instructions may be for component computations of a complex computation. The data movement instructions may be for routing computation data for the complex computation. In specific embodiments, both computational instructions and data movement instructions may be part of a RISC-V instruction set.

In specific embodiments, at step 604, a configurable mapping may be stored by the set of processing cores. The configurable mapping may map a configurable global address space to physical addresses in the one or more memories. A subset of the data movement instructions (e.g., stored at step 602) may be configuration instructions for the configurable global address space for the set of processing cores.

At step 606, an execution of the computational instructions (e.g., stored at step 602) for the component computations of the complex computation may be administrated by a set of computational pipelines on the set of processing cores. The execution of the computational instructions may be administrated using a set of core controllers on the set of processing cores. In specific embodiments, the core controller may be a control unit in a RISC-V architecture.

At step 608, an execution of the data movement instructions (e.g., stored at step 602) may be administrated using a set of data movement core controllers on the set of data movement processing cores. In specific embodiments, the data movement core controllers in the set of data movement core controllers may each include a program counter and a decoder stage. In specific embodiments, the core controllers in the set of core controllers and the data movement core controllers in the set of data movement core controllers may all use their own separate program counters. In specific embodiments, step 606 and step 608 may be performed in parallel.

In specific embodiments, at step 610, the computation data may be stored in a set of scratch pad memories. The one or more memories may include the set of scratch pad memories. In specific embodiments, both the set of processing cores and the set of data movement processing cores may have access (e.g., read and write) to the set of scratch pad memories. In specific embodiments, step 610 may be part of step 606, step 608, or both.

In specific embodiments, at step 612, a data type of the computation data may be changed using a subset of the data movement instructions.

In specific embodiments, at step 614, a compression state of the computation data may be changed using a subset of the data movement instructions.

In specific embodiments, at step 616, a quantity of data structures storing the computation data may be changed using a subset of the data movement instructions.

The subset of the data movement instructions of steps 612, 614, and 616 may be data reformatting instructions. In specific embodiments, the subset of the data movement instructions may be executed without the computation data that is reformatted flowing through the set of computational pipelines. In specific embodiments, the subset of the data movement instructions may reformat the computation data in a manner that is dependent upon intermediate results of the execution of the complex computation. In specific embodiments, the set of data movement processing cores may reformat the computation data during the execution of the complex computation and using conditional logic. In specific embodiments, the set of data movement processing cores may receive information regarding a state of the interconnect fabric during the complex computation and the conditional logic may use the information regarding the state of the interconnect fabric. In specific embodiments, steps 612, 614, and/or 616 may be part of step 608.

At step 618, a set of commands for a set of routers on the set of processing cores may be generated. The set of commands may be generated via the execution of the data movement instructions (e.g., at step 608). In specific embodiments, the commands for the router may route data for the complex computation on and off the processing core. In specific embodiments, step 620 may be part of step 608.

At step 620, the computation data may be routed through the interconnect fabric during the execution of the complex computation. The computation data may be routed using the set of routers.

In specific embodiments and as part of routing the computation data, at step 622, the computation data (e.g., stored at step 610) may be moved from the set of scratch pad memories through the interconnect fabric. The computation data may be moved by the routers in the set of routers. The routers in the set of routers and the scratch pad memories in the set of scratch pad memories may be communicatively coupled. In specific embodiments, the routers may each include a network-on-chip interface.

By using a fully functional and programmable processing core to administrate the network, several benefits can be realized. A fully functional and programmable processing core such as a data movement processing core may allow the configuration to be changed by software during execution of a composite computation and the interconnect fabric can be optimized for different data movements at different times. Furthermore, different sections of a shared or global distributed memory can be assigned to a specific core and each data movement processing core can maintain an address directory indicating which addresses are associated with each core. Furthermore, in specific embodiments each data movement processing core can maintain a table indicating where specific data elements or variables used in the complex computation are located so they can send specific requests for a given data element to the appropriate core. These tables and directories can be initialized and modified through the course of a composite computation using software. The tables and directories can be instantiated using programmable registers in the network control processing cores that control the movement of data through the system.

Specific embodiments of these approaches are valuable for addressing NoCs that are used for executing composite computations with unpredictable data movement patterns that require a high degree of flexibility in the administration of data movement through the NoC. For example, the execution of modern ANNs and other machine intelligence models tends to have unpredictable data movement patterns based on the activations to the network such that this field in particular can benefit from a NoC that uses data movement processing cores in accordance with this disclosure.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in the disclosure were generally directed to a processing core with a computational pipeline, the same approaches could be utilized to improve efficiency for any computational node with any type of functional processing units. These and other modifications and variations to the present invention may be practiced by those skilled in the art, without departing from the scope of the present invention, which is more particularly set forth in the appended claims.

What is claimed is:

1. A system comprising:
a set of processing cores;
a set of one or more memories, on the set of processing cores, storing computational instructions for component computations of a complex computation and storing data movement instructions for routing computation data for the complex computation;
an interconnect fabric that networks the set of processing cores;
a set of computational pipelines on the set of processing cores;
a set of core controllers on the set of processing cores to administrate an execution of the computational instructions by the set of computational pipelines;
a set of routers on the set of processing cores;
a set of data movement processing cores on the set of processing cores; and
a set of data movement core controllers, on the set of data movement processing cores, to administrate an execution of the data movement instructions and thereby generate commands for the set of routers to route the computation data through the interconnect fabric during an execution of the complex computation.

2. The system of claim 1, wherein:
the data movement core controllers in the set of data movement core controllers each include a program counter and a decoder stage; and
the data movement processing cores in the set of data movement processing cores each include a functional processing unit.

3. The system of claim 1, wherein:
the core controllers in the set of core controllers and the data movement core controllers in the set of data movement core controllers all use their own separate program counters.

4. The system of claim 1, wherein:
the set of one or more memories includes a set of scratch pad memories; and
the set of scratch pad memories store the computation data.

5. The system of claim 4, wherein:
the routers in the set of routers and the scratch pad memories in the set of scratch pad memories are communicatively coupled; and
the routers in the set of routers move the computation data from the set of scratch pad memories through the interconnect fabric.

6. The system of claim 1, wherein:
a subset of the data movement instructions are configuration instructions for a configurable global address space for the set of processing cores; and
the set of processing cores store a configurable mapping that maps the configurable global address space to physical addresses in the set of one or more memories.

7. The system of claim 1, wherein:
a subset of the data movement instructions are data reformatting instructions; and
the data reformatting instructions: (i) change a data type of the computation data; (ii) change a compression state of the computation data; and (iii) change a quantity of data structures storing the computation data.

8. The system of claim 7, wherein:
the subset of the data movement instructions are executed without the computation data that is reformatted flowing through the set of computational pipelines.

9. The system of claim 7, wherein:
the subset of the data movement instructions reformat the computation data in a manner that is dependent upon intermediate results of the execution of the complex computation.

10. The system of claim 1, wherein:
the set of data movement processing cores reformat the computation data during the execution of the complex computation and using conditional logic.

11. The system of claim 10, wherein:
the set of data movement processing cores receive information regarding a state of the interconnect fabric during the complex computation; and
the conditional logic uses the information regarding the state of the interconnect fabric.

12. A method, in which each step is conducted by a set of processing cores, having a set of data movement processing cores, and an interconnect fabric that networks the set of processing cores, comprising:
storing, in one or more memories on the set of processing cores, computational instructions for component computations of a complex computation and data movement instructions for routing computation data for the complex computation;
administrating, using a set of core controllers on the set of processing cores, an execution of the computational instructions for the component computations of the complex computation by a set of computational pipelines on the set of processing cores;
administrating, using a set of data movement core controllers on the set of data movement processing cores, an execution of the data movement instructions;
generating, via the execution of the data movement instructions, a set of commands for a set of routers on the set of processing cores; and
routing, using the set of routers, the computation data through the interconnect fabric during an execution of the complex computation.

13. The method of claim 12, wherein:
the data movement core controllers in the set of data movement core controllers each include a program counter and a decoder stage; and
the data movement processing cores in the set of data movement processing cores each include a functional processing unit.

14. The method of claim 12, wherein:
the core controllers in the set of core controllers and the data movement core controllers in the set of data movement core controllers all use their own separate program counters.

15. The method of claim 12, further comprising:
storing the computation data in a set of scratch pad memories, the one or more memories including the set of scratch pad memories.

16. The method of claim 15, wherein routing the computation data through the interconnect fabric comprises:
moving, by the routers in the set of routers, the computation data from the set of scratch pad memories through the interconnect fabric, the routers in the set of routers and the scratch pad memories in the set of scratch pad memories being communicatively coupled.

17. The method of claim 12, further comprising:
storing, by the set of processing cores, a configurable mapping that maps a configurable global address space to physical addresses in the one or more memories, a subset of the data movement instructions being configuration instructions for the configurable global address space for the set of processing cores.

18. The method of claim 14, further comprising:
changing a data type of the computation data using a subset of the data movement instructions, the subset of the data movement instructions being data reformatting instructions;
changing a compression state of the computation data using the subset of the data movement instructions; and
changing a quantity of data structures storing the computation data using the subset of the data movement instructions.

19. A processing core comprising:
one or more memories storing computational instructions for component computations of a complex computation and data movement instructions for routing data for the complex computation;
a computational pipeline;
a core controller to administrate an execution of the computational instructions by the computational pipeline;
a router having a network-on-chip interface;
a data movement processing core; and
a data movement core controller, on the data movement processing core, to administrate an execution of the data movement instructions and thereby generate commands for the router to route data for the complex computation on and off the processing core.

20. The processing core of claim 19 wherein:
the core controller and the data movement core controller use their own separate program counters.
